(19) United States
(12) Patent Application Publication
(10) Pub. No.: US 2023/0166211 A1
(43) Pub. Date: Jun. 1, 2023

(54) STATE QUANTITY PREDICTION DEVICE AND STATE QUANTITY PREDICTION METHOD

(71) Applicant: MITSUBISHI HEAVY INDUSTRIES, LTD., Tokyo (JP)

(72) Inventors: Yusuke Hazui, Tokyo (JP); Mizuho Takeuchi, Tokyo (JP); Shunsuke Takagaki, Tokyo (JP); Koki Tateishi, Tokyo (JP); Shinya Kanemori, Tokyo (JP)

(73) Assignee: MITSUBISHI HEAVY INDUSTRIES, LTD., Tokyo (JP)

(21) Appl. No.: 18/058,362

(22) Filed: Nov. 23, 2022

(30) Foreign Application Priority Data
Dec. 1, 2021 (JP) 2021-195234

(51) Int. Cl. B01D 53/14; B01D 53/50; G06F 18/2137

(52) U.S. Cl. CPC B01D 53/1412; B01D 53/50; G06F 18/21375; B01D 2258/0283

(57) ABSTRACT

A state quantity prediction device includes: a first differential predictive value calculation unit configured to deal with a nonlinear component of a function whose variables are dynamic characteristics of the state quantity with respect to the input parameter and a difference value between a past predictive value of the state quantity and a predictive value of the physical model, input the input parameter and the past predictive value of the state quantity, and include a learned neutral network for outputting a first differential predictive value; a second differential predictive value calculation unit configured to deal with a linear component of the function, input the input parameter and the past predictive value, and output a second differential predictive value; and a state quantity predictive value calculation unit configured to calculate a predictive value of the state quantity.

### TECHNICAL FIELD

The present disclosure relates to a state quantity prediction device and a state quantity prediction method.

### BACKGROUND

In an equipment such as a plant, a state quantity may be predicted by computation using a numerical model for a purpose of monitoring, control, abnormality determination, or the like. A numerical model of this kind includes, for example, a physical model based on a static equilibrium equation or an equation of state derived from physical knowledge, or a statistical model such as a machine learning model using a neural network, multiple regression analysis, or the like.

If the physical model is used as the numerical model, the physical model may perform approximation such as linearization assuming that a true prediction expression is linear or may perform modelization assuming, for example, an operating condition in statically determinate time or the like. However, such a physical model may result in an increase in large prediction error, if the assumed precondition is not met. Further, in the statistical model such as the machine learning model, a prediction error may increase in an extrapolation area of learning data used when the model is constructed.

Thus, Patent Document 1 proposes a prediction method for correcting an error in state quantity predicted by a physical model with a machine learning model, by learning a deviation between a state quantity derived by the physical model and a measured quantity with machine learning. This method is, so to speak, a prediction method that combines the physical model and the machine learning model, but dynamic characteristics of the state quantity to be predicted are not considered in the machine learning model. Consequently, sufficient prediction accuracy may not be obtained for a target whose state quantity has the dynamic characteristics.

As one of methods for solving such problem with the dynamic characteristics, it is conceivable to introduce a Recurrent Neural Network (RNN) as the machine learning method. On the other hand, a neural ODE (Neural Ordinary Differential Equation), which is a continuous representation neural network introducing a differential structure, has advantages of having higher memory efficiency than the RNN and being able to handle a temporally continuous model.

Non-Patent Document 1 discloses a prediction method capable of improving prediction accuracy by combining the neural ODE and the known differential equation.

### Citation List

### Patent Literature

Patent Document 1: JP2882232B

### Non-Patent Literature

Non-Patent Document 1: Manuel A. Roehrl, Modeling System Dynamics with Physics Informed Neural Networks Based on Lagrangian Mechanics, IFAC, 2020

### SUMMARY

In order to consider the dynamic characteristics of the state quantity to be predicted in the machine learning model, in Patent Document 1, if the aforementioned neural ODE is applied as the machine learning method, the neural ODE learns “dynamic characteristics of a prediction error” between the state quantity and the static physical model. In this case, in the machine learning, it is necessary to learn not only the dynamic characteristics of the state quantity but also dynamic characteristics of an equilibrium point. Herein, FIG. 4 is a graph showing a temporal change in state quantity x if a prediction target transitions from a first equilibrium state to a second equilibrium state at a time t1, and FIG. 5 is a graph showing a temporal change in error Δx between equilibrium points x1 and x2 of the state quantity x in FIG. 4. As shown in FIG. 4, the state quantity x is at the first equilibrium point x1 corresponding to the first equilibrium state before the time t1, but changes toward the second equilibrium point x2 corresponding to the second equilibrium state if the transition to the second equilibrium state occurs at the time t1. At this time, the state quantity x does not immediately reach the second equilibrium point x2, but changes so as to asymptotically approach the second equilibrium point x2 toward a time t2. Therefore, as shown in FIG. 5, the error Δx exhibits a behavior of abruptly increasing at the time t1 and then asymptotically decreasing toward the time t2. Thus, if a dynamic change in which the equilibrium point changes discontinuously occurs at a certain time (time t1), a differential value (or the error Δx) of the state quantity x that changes so as to follow the equilibrium point shows steep and nonlinear behavior. Therefore, in the above-described technique, the scale (degree of freedom) of the neural network must be increased in order to learn such nonlinear behavior, which may cause a decrease in generalization performance due to overlearning.

Further, in Non-Patent Document 1, the known differential equation which is the physical model is combined with the neural ODE. Since an output of the neural ODE is the differential value of the state quantity to be predicted, the physical model combined with the neural ODE also needs to match its output with the differential value of the state quantity to be predicted. Therefore, the method of Non-Patent Document 1 cannot be used, if it is possible to obtain, as the physical model, only a static physical model that outputs not the differential value but the value itself of the state quantity to be predicted (for example, a chemical equilibrium formula, a balance equation for heat balance, or the like).

At least one embodiment of the present disclosure has been made in view of the above, and an object of the present disclosure is to provide a state quantity prediction device and a state quantity prediction method capable of predicting a state quantity in consideration of dynamic characteristics by using a static physical model.

In order to solve the above-described problems, a state quantity prediction device according to at least one embodiment of the present disclosure is a state quantity prediction device for predicting, by using a physical model for supporting an equipment in a static state, a state quantity of the equipment corresponding to an input parameter regarding the equipment, that includes: a first differential predictive value calculation unit configured to deal with a nonlinear component of a function whose variables are dynamic characteristics of the state quantity with respect to the input parameter and a difference value between a past predictive value of the state quantity and a predictive value of the physical model, input the input parameter and the past predictive value of the state quantity, and include a learned neutral network for outputting a first differential predictive value; a second differential predictive value calculation unit configured to deal with a linear component of the function, input the input parameter and the past predictive value, and output a second differential predictive value; and a state quantity predictive value calculation unit configured to calculate a predictive value of the state quantity by integrating a differential predictive value calculated based on the first differential predictive value and the second differential predictive value.

In order to solve the above-described problems, a state quantity prediction method according to at least one embodiment of the present disclosure is a state quantity prediction method for predicting, by using a physical model for supporting an equipment in a static state, a state quantity of the equipment corresponding to an input parameter regarding the equipment, that includes: a step of dealing with a nonlinear component of a function whose variables are dynamic characteristics of the state quantity with respect to the input parameter and a difference value between a past predictive value of the state quantity and a predictive value of the physical model, inputting the input parameter and the past predictive value of the state quantity, and including a learned neutral network for outputting a first differential predictive value; a step of dealing with a linear component of the function, inputting the input parameter and the past predictive value, and outputting a second differential predictive value; and a step of calculating a predictive value of the state quantity by integrating a differential predictive value calculated based on the first differential predictive value and the second differential predictive value.

According to at least one embodiment of the present disclosure, it is possible to provide a state quantity prediction device and a state quantity prediction method capable of predicting a state quantity in consideration of dynamic characteristics by using a static physical model.

### BRIEF DESCRIPTION OF DRAWINGS

FIG. 1 is a configuration diagram of a state quantity prediction device according to an embodiment.

FIG. 2 is a schematic diagram showing a neural network NN of a first differential predictive value calculation unit of FIG. 1.

FIG. 3 is a diagram schematically showing the configuration of a desulfurizer.

FIG. 4 is a graph showing a temporal change in state quantity if a prediction target transitions from a first equilibrium state to a second equilibrium state at a time.

FIG. 5 is a graph showing a temporal change in error between equilibrium points of the state quantity in FIG. 4.

### DETAILED DESCRIPTION

Some embodiments of the present invention will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

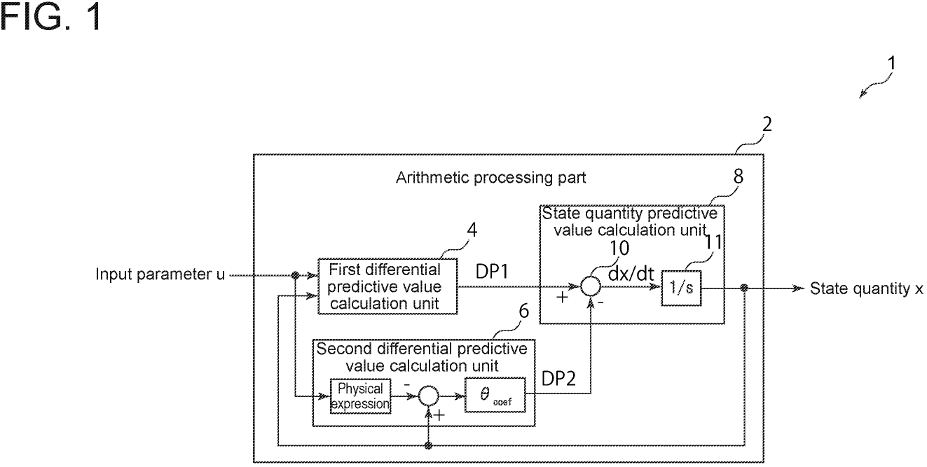

FIG. 1 is a configuration diagram of a state quantity prediction device 1 according to an embodiment. The state quantity prediction device 1 receives at least one input parameter u regarding an equipment to be predicted and outputs a predictive value of a state quantity x. The predictive value of the state quantity x is obtained by an arithmetic processing part 2 configured to perform arithmetic processing using a static physical model M. The arithmetic processing part 2 includes a first differential predictive value calculation unit 4 for calculating a first differential predictive value DP1, a second differential predictive value calculation unit 6 for calculating a second differential predictive value DP2, and a state quantity predictive value calculation unit 8 for calculating a predictive value of the state quantity x based on the first differential predictive value DP1 and the second differential predictive value DP2.

Although a hardware configuration for realizing such state quantity prediction device 1 is not limited, for example, the state quantity prediction device 1 is configured as an information processing device that includes a CPU (Central Processing Unit), a RAM (Random Access Memory), a ROM (Read Only Memory), a computer-readable storage medium, and the like. Then, a series of processes for realizing various functions is stored in the storage medium or the like in the form of a program, as an example. The CPU reads the program out to the RAM or the like and executes processing/calculation of information, thereby realizing the various functions. The program may be applied with a configuration where the program is installed in the ROM or another storage medium in advance, a configuration where the program is provided in a state of being stored in the computer-readable storage medium, a configuration where the program is distributed via a wired or wireless communication means, or the like. The computer-readable storage medium is a magnetic disk, a magneto-optical disk, a CD-ROM, a DVD-ROM, a semiconductor memory, or the like.

The static physical model M used by the arithmetic processing part 2 is a physical model for supporting an equipment in a static state, and is configured to output the state quantity x of the equipment corresponding to the input parameter u in statically determinate time. Such physical model M is generally represented, as a relational expression between the state quantity x and the input parameter u in statically determinate time, by:

$$\text{x} = \text{f} \left(\text{u} , {θ}_{\text{phy}}\right)$$

where θ_{phy} is at least one physical parameter included in the physical model M, and f is any function whose variables are the input parameter u and the physical parameter θ_{phy}.

Herein, in order to predict the state quantity x in consideration of dynamic characteristics, a differential predictive value dx/dt of the state quantity x is represented by:

$$\text{dx} / \text{dt} = \text{g} \left(\text{x} , \text{u}\right) - \text{h} \left(\text{x} - \text{f} \left(\text{u} , {θ}_{\text{phy}}\right)\right)$$

In equation (2), the first term on the right side is a function g(x, u) indicating unknown dynamic characteristics, and the second term on the right side is a function whose variables are dynamic characteristics of the state quantity x with respect to the input parameter u and a difference value between a past predictive value of the state quantity x and a predictive value f(u, θ_{Phy}) of the physical model M.

The above equation (2) can be transformed into:

$$\text{dx/dt=NN} \left(\text{x,} \text{u,} {\text{θ}}_{\text{NN}}\right) - {\text{θ}}_{\text{coef}} \left(\text{x} - \text{f} \left(\text{u} , {\text{θ}}_{\text{phy}}\right)\right)$$

The second term (h(x-f(u, θ_{phy}))) on the right side of the above equation (2) can be separated into a nonlinear component and a linear component. Of these, the nonlinear component is expressed by a neural network together with the first term (unknown dynamic characteristic g(x, u)) on the right side of the above equation (2), and the linear component is expressed by a linear form of the physical model and the state quantity. Thus, by combining the neural ODE and the static physical model M, it is possible to predict the state quantity x in consideration of the dynamic characteristics.

In the above equation (3), a coefficient θ_{NN} included in the neural network, a linear variable θ_{coef} included in the linear component, and a physical parameter θ_{phy} are learned in advance by using teacher data. As a learning method, various methods such as backpropagation can be used.

The first differential predictive value calculation unit 4 is configured as a neural network for outputting, as the first differential predictive value DP1, a first term (NN(x, u, θ_{NN})) of the above equation (3) as a predictive value. More specifically, to the first differential predictive value calculation unit 4, the input parameter u and the past predictive value of the state quantity x are input, and NN(x, u, θ_{NN}) is output as the first differential predictive value DP1.

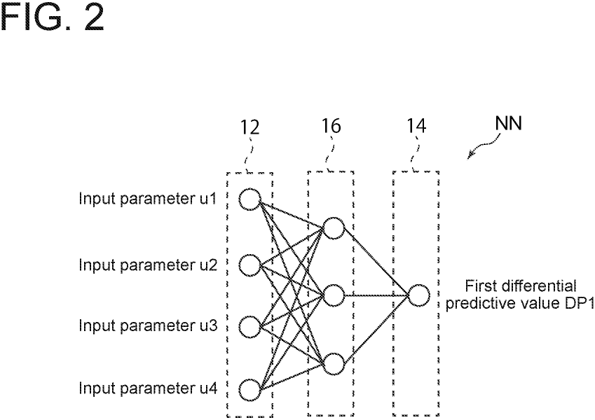

FIG. 2 is a schematic diagram showing the neural network NN of the first differential predictive value calculation unit 4 of FIG. 1. The neural network NN includes an input layer 12 to which a plurality of input parameters u1, u2, ... are input, an output layer 14 from which the first differential predictive value DP1 is output as a prediction result, and an intermediate layer 16 (hidden layer) located between the input layer 12 and the output layer 14 and including a plurality of nodes. Such neural network NN is learned in advance as described above, but the nodes of the intermediate layer 16 include the physical parameter θ_{phy} of the physical model M, and the physical parameter θ_{phy} may be learned simultaneously with the coefficients θ_{NN} included in the neural network and the linear variable θ_{coef} included in the linear component.

It may be impossible to explicitly derive a value of the physical parameter θ_{phy} inherent to the physical model M. In this case, it is conceivable that a human sets a temporary value for the physical parameter θ_{phy}. However, it is likely that the physical parameter θ_{phy} thus set contains an error with respect to a true value. It is also conceivable to identify the physical parameter θ_{phy} based on operation data. Also in this case, however, if the structure of the physical model M contains an error, the value of the physical parameter θ_{phy} obtained by the identification may contain the error with respect to the true value. By contrast, since the physical parameter θ_{phy} is learned simultaneously with the coefficient θ_{NN} included in the neural network and the linear variable θ_{coef} included in the linear component as described above, it is possible to reduce the prediction error of the physical model M alone and to expect an improvement in estimation accuracy of the state quantity x.

In this case, if the physical parameter θ_{phy} obtained by learning deviates from an allowable range, the physical parameter θ_{phy} may be regularized. The allowable range is set in advance as a range where the physical parameter θ_{phy} is empirically or theoretically assumed. If the physical parameter θ_{phy} deviating from the allowable range is obtained by learning, the physical model M reflecting the physical parameter θ_{phy} may be diverted from the true model and lose generalization performance. Therefore, for the physical parameter θ_{phy}, the allowable range is set in advance as, for example, a range of a physically conceivable true value, and regularization is performed such that a loss function value increases when the physical parameter θ_{phy} deviates from the allowable range. Such regularization enables learning such that the physical parameter θ_{phy} converges within the allowable range, and as a result, the physical model M is not diverted from the true model and high generalization performance can be maintained.

The second differential predictive value calculation unit 6 is configured to output, as the second differential predictive value DP2, a second term (θ_{coef}(x-f(u, θ_{phy}))) of the above equation (3). More specifically, to the second differential predictive value calculation unit 6, the input parameter u is input, as well as the past predictive value of the state quantity x is feedback input and θ_{coef}(x-f(u, θ_{phy})) is output as the second differential predictive value DP2.

The input parameter u input to the first differential predictive value calculation unit 4 and the second differential predictive value calculation unit 6 may be common to each other or may be different from each other (that is, they may not completely be the same).

The state quantity predictive value calculation unit 8 is configured to calculate the predictive value of the state quantity x based on the first differential predictive value DP1 calculated by the first differential predictive value calculation unit 4 and the second differential predictive value DP2 calculated by the second differential predictive value calculation unit 6. More specifically, the state quantity predictive value calculation unit 8 is configured to calculate the differential predictive value dx/dt as a difference between the first differential predictive value DP1 and the second differential predictive value DP2 by inputting the first differential predictive value DP1 and the second differential predictive value DP2 to a subtractor 10. Then, the differential predictive value dx/dt output from the subtractor 10 is input to an integrator 11, thereby calculating the predictive value of the state quantity x.

Herein, since the state quantity predictive value calculation unit 8 is configured to calculate the predictive value of the state quantity by integrating the differential predictive value dx/dt, the initial value of the state quantity x is required. Therefore, the state quantity predictive value calculation unit 8 may set, as an initial value xᵢₙᵢₜ, a state quantity that satisfies a condition where the differential predictive value becomes zero (that is, the state quantity is statically determined), or more specifically the following:

$$N N \left(x , u , {θ}_{N N}\right) - {θ}_{c o e f} \left(x - f \left(u , {θ}_{p h y}\right)\right) = 0$$

$${\hat{x}}_{i n i t} = arg {min}_{x} {\left(N N \left(x , u , {θ}_{N N}\right) - {θ}_{c o e f} \left(x - f \left(u , {θ}_{p h y}\right)\right)\right)}^{2}$$

More specifically, a value derived by solving equation (5) with a nonlinear optimization method (such as quasi-Newton method, sequential quadratic programming, or the like) may be employed as the initial value xᵢₙᵢₜ. Thus, it is possible to predict the state quantity x based on the correct initial value xᵢₙᵢₜ, and it is possible to expect an improvement in prediction accuracy compared to a case where the prediction is performed based on the erroneous initial value xᵢₙᵢₜ.

Subsequently, a specific application example of the state quantity prediction device 1 having the above configuration will be described. Herein, as a specific example of predicting the state quantity of the equipment, a case will be exemplified where an absorbent concentration of an absorption liquid used in an absorption tower of a flue gas desulfurization plant is predicted as the state quantity. As another example, the present disclosure may be targeted at a gas turbine, a steam turbine, a large refrigerator, an air conditioner, or the like.

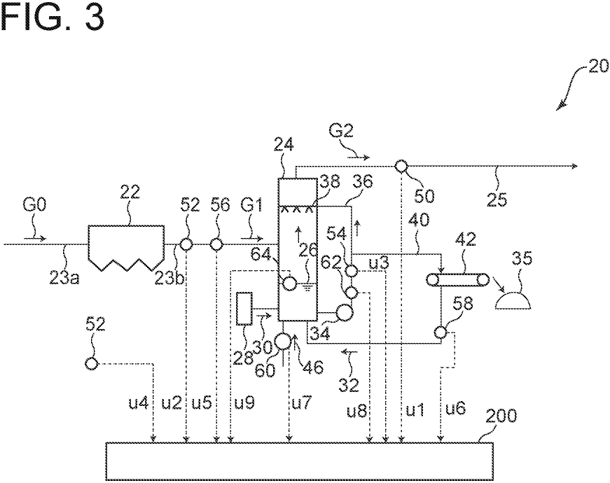

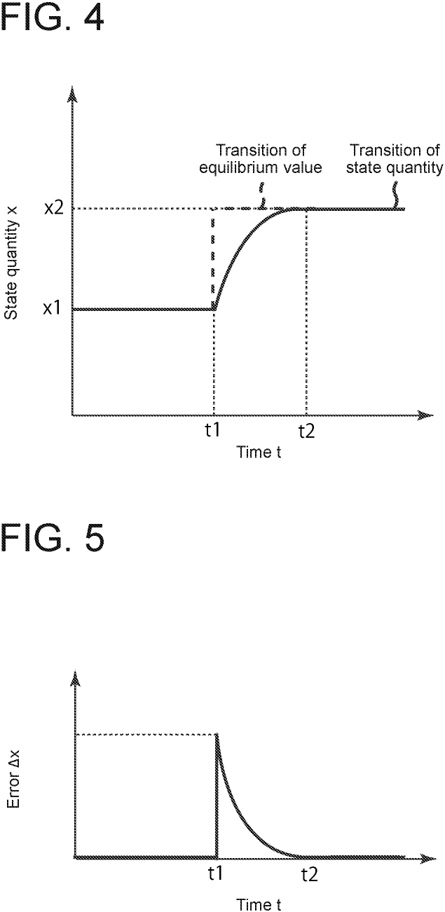

FIG. 3 is a diagram schematically showing the configuration of a desulfurizer 20. The desulfurizer 20 is installed accompanying a boiler (not shown) for a plant facility such as a thermal power plant, and includes a dust collecting device 22 and an absorption tower 24 downstream of the dust collecting device 22. The dust collecting device 22 is configured to collect fine particles which are contained in a flue gas G0 flowing through an exhaust passage 23a of the boiler. The absorption tower 24 is installed on an exhaust passage 23b through which a flue gas G1 having passed through the dust collecting device 22 flows.

The dust collecting device 22 is an electric precipitator for collecting dust by charging the fine particles, which are contained in the flue gas G0 supplied into a casing, by performing corona discharge on the flue gas G0, and adhering the fine particles to a positively and negatively charged adhesion part with an electric attraction force. The flue gas G1 having undergone the dust collection by the dust collecting device 22 is supplied to the absorption tower 24 via the exhaust passage 23b.

The absorption tower 24 performs desulfurization treatment through absorption of SO₂ (sulfur dioxide) in the flue gas G1 by bringing an absorption liquid 26 containing limestone 30 into contact with the flue gas G1 having undergone the dust collection by the dust collecting device 22. The absorption liquid 26 is stored in the bottom of the absorption tower 24. The absorption liquid 26 is produced by mixing the limestone 30, which is supplied from a limestone feeder 28 disposed outside the absorption tower 24, with water 32 supplied to the bottom of the absorption tower 24.

In the present embodiment, the case is exemplified where the absorption liquid 26 is produced by supplying the limestone 30 to the water 32 from the limestone feeder 28. Instead of this, however, the absorption liquid 26 may be produced by supplying limestone slurry containing limestone to the water 32.

The absorption liquid 26 stored in the bottom of the absorption tower 24 is pumped by an absorbent circulation pump 34 and supplied to an upper portion of the absorption tower 24 via an absorbent header 36 disposed outside the absorption tower 24. The absorbent circulation pump 34 is composed of a plurality of pump units connected in parallel, and an operating state of each pump unit is controlled. For example, if each pump unit is of a variable displacement type (rotor blade type), the flow rate of the absorption liquid 26 pumped from the absorbent circulation pump 34 can be controlled by variably adjusting the capacity of each pump unit. Further, if each pump unit is of a fixed capacity type (fixed blade type), the flow rate of the absorption liquid 26 pumped from the absorbent circulation pump 34 can be controlled by adjusting the number of operating pump units. The absorption liquid 26 thus supplied to the upper portion of the absorption tower 24 contacts the flue gas G1 rising inside the absorption tower 24 as the absorption liquid 26 is sprayed and dropped from a nozzle 38 disposed in the upper portion of the absorption tower 24. Consequently, SO₂ contained in the flue gas G1 reacts with the limestone 30 in the absorption liquid 26, and the desulfurization treatment is performed.

The method of spraying and dropping the absorption liquid 26 from the nozzle 38 may be a grid method, a liquid column method, or a spray method.

A chemical reaction formula of the desulfurization treatment performed in the absorption tower 24 can be represented by:

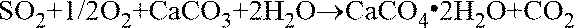

In the desulfurization reaction, gypsum 35 (CaCO₄ · 2H₂O) is produced as a byproduct through the reaction between the limestone 30 and SO₂ contained in flue gas G1. A flue gas G2 from which SO₂ has been removed is discharged from the top of the absorption tower 24 to the outside via a desulfurization flue gas pipe 25.

Further, part of the absorption liquid 26 stored in the bottom of the absorption tower 24 is sent to a dehydrator 42 via an extraction pipe 40 branched from the absorbent header 36 outside the absorption tower 24, while being pumped by the absorbent circulation pump 34. The dehydrator 42 is composed of, for example, a belt filter and dehydrates the absorption liquid 26 as the absorption liquid 26 is conveyed by the belt filter, and the produced gypsum 35 is discharged to the outside of the system.

Filtrate generated in the dehydration treatment by the dehydrator 42 is supplied as the water 32 to the bottom of the absorption tower 24 and reused.

Further, oxidizing air 46 is supplied to the bottom of the absorption tower 24. Consequently, since the absorption liquid 26 includes the oxidizing air 46, oxidation to a sulfate group from a sulfite group generated by transfer from the SO₂ flue gas into the absorption liquid 26 is promoted, resulting in improvement in removal efficiency of SO₂ in the flue gas as well.

If the method of spraying and dropping the absorption liquid 26 from the nozzle 38 is the grid method, the absorption liquid 26 is oxidized in the process of dropping, and thus the supply of the oxidizing air 46 may be omitted.

In such desulphurization device 20, at least one sensor is disposed which is selectable as the aforementioned input parameter u. In the present embodiment, provided are an SO₂ concentration sensor 50 for detecting the SO₂ concentration u1 on an outlet side of the absorption tower 24 (desulfurization outlet SO2 concentration [ppm]), an SO2 concentration sensor 52 for detecting the SO2 concentration u2 on an inlet side of the absorption tower 24 (desulfurization inlet SO2 concentration [ppm]), a limestone slurry flow rate sensor 54 for detecting the flow rate u3 of the limestone slurry produced in the absorption tower 24 (absorption tower limestone slurry flow rate [m³/h]), a boiler air flow rate sensor 56 for detecting the boiler air flow rate u5 [%], and a limestone slurry concentration sensor 58 for detecting the concentration u6 of the limestone slurry produced in the absorption tower 24 (absorption tower limestone slurry concentration [wt%]), an oxidizing air flow rate sensor 60 for detecting the oxidizing air flow rate u7 [m³N/h] supplied to the absorption tower 24, a pH sensor 62 for detecting the pH u8 of the absorption liquid 26 in the absorption tower 24 (absorption tower pH), and a level sensor 64 for detecting the level u9 of the absorption liquid 26 in the absorption tower 24 (absorption tower level [m]).

Further, the power generation command signal u4 with respect to a generator (not shown) for generating electricity with steam produced in a boiler (not shown) can also be obtained as the input parameter u.

At least one of the detected values of these sensors is input to the aforementioned state quantity prediction device 1 as the input parameter u, whereby the state quantity prediction device 1 predicts the absorbent (calcium carbonate) concentration [mmol/L] in the absorption tower 24 as the state quantity x.

The state quantity prediction device 1 can use the various parameters regarding the desulfurizer 20 as the physical parameters θ_{phy} of the physical model M, and may include, for example, at least one of a limestone activity in the absorption liquid 26, a water content in inlet gas of the absorption tower 24, or a humidifying rate in the absorption tower 24.

The state quantity prediction device 1 having such configuration is connected via a network to each sensor disposed in the desulfurizer 20, whereby the result detected by each sensor can be obtained as the input parameter u. Thus, the state quantity prediction device 1 can predict the absorbent (calcium carbonate) concentration [mmol/L] as the state quantity x corresponding to the input parameter u to be used for the operation of the desulfurizer 20.

As for the rest, without departing from the spirit of the present disclosure, it is possible to replace the constituent elements in the above-described embodiments with known constituent elements, respectively, as needed and further, the above-described embodiments may be combined as needed.

The contents described in the above embodiments would be understood as follows, for instance.

(1) A state quantity prediction device according to one aspect is a state quantity prediction device (1) for predicting, by using a physical model for supporting an equipment in a static state, a state quantity (x) of the equipment corresponding to an input parameter (u) regarding the equipment, that includes: a first differential predictive value calculation unit (4) configured to deal with a nonlinear component of a function whose variables are dynamic characteristics of the state quantity with respect to the input parameter and a difference value between a past predictive value of the state quantity and a predictive value of the physical model, input the input parameter and the past predictive value of the state quantity, and include a learned neutral network (NN) for outputting a first differential predictive value (DP1); a second differential predictive value calculation unit (6) configured to deal with a linear component of the function, input the input parameter and the past predictive value, and output a second differential predictive value (DP2); and a state quantity predictive value calculation unit (8) configured to calculate a predictive value of the state quantity by integrating a differential predictive value calculated based on the first differential predictive value and the second differential predictive value.

With the above configuration (1), the function whose variable is the difference value between the past predictive value and the predictive value obtained based on the static physical model is divided into the nonlinear component and the linear component. The nonlinear component is used by the learned neural network to calculate the first differential predictive value, together with the dynamic characteristics of the state quantity with respect to the input parameter. The first differential predictive value is used to calculate the differential predictive value, together with the second differential predictive value obtained based on the one linear component. The state quantity is predicted by integrating the differential predictive value thus calculated. Thus, it is possible to accurately predict the state quantity in consideration of the dynamic characteristics, even if only the static physical model can be obtained for the equipment.

Note that “the equipment in the static state” means that the equipment is in the state where the dynamic characteristics are not taken into consideration, and refers to, for example, the state where the relationship between the input parameter regarding the equipment and the state quantity of the equipment can be expressed by the static expression.

(2) In another aspect, in the above aspect (1), the neural network is learned together with a linear coefficient of the linear component and a physical parameter regarding the equipment included in the physical model.

With the above configuration (2), since the neural network is learned simultaneously with the learning of the linear coefficient of the linear component and the physical parameter regarding the equipment included in the physical model, it is possible to reduce the prediction error of the physical model alone and to expect the improvement in estimation accuracy of the state quantity x.

(3) In another aspect, in the above aspect (2), the physical parameter is regularized if the physical parameter deviates from a preset allowable range.

With the above configuration (3), for the physical parameter obtained by the learning, the allowable range is set in advance as, for example, the range of the physically conceivable true value, and regularization is performed when the physical parameter deviates from the range. Thus, it is possible to learn such that the physical parameter converges within the allowable range, and as a result, the physical model M is not diverted from the true model and high generalization performance can be maintained.

(4) In another aspect, in any one of the above aspects (1) to (3), the state quantity prediction value calculation unit is configured to integrate the differential predictive value by using, as an initial value, the state quantity satisfying a condition where the differential predictive value becomes zero.

With the above configuration (4), the initial value of the state quantity, which is required when the predictive value of the state quantity is calculated by integrating the differential predictive value, is obtained under the condition where the differential predictive value becomes zero (that is, the state quantity is statically determined). Thus, it is possible to predict the state quantity based on the highly reliable initial value, and it is possible to expect the improvement in prediction accuracy compared to the case where the prediction is performed based on the erroneous initial value.

(5) In another aspect, in any one of the above aspects (1) to (4), the equipment is a flue gas desulfurization plant for desulfurizing a flue gas by bringing an absorption liquid into contact with the flue gas in an absorption tower, and the state quantity is an absorbent concentration of the absorption liquid in the absorption tower.

With the above configuration (5), it is possible to suitably predict, as the state quantity, the absorbent concentration of the absorption liquid in the absorption tower of the flue gas desulfurization plant.

(6) In another aspect, in the above aspect (5), the input parameter includes at least one of a desulfurization outlet SO2 concentration of the absorption tower, a desulfurization inlet SO2 concentration of the absorption tower, a flow rate or a concentration of limestone slurry produced in the absorption tower, a power generation command signal with respect to a generator for generating electricity with steam produced in a boiler for discharging the flue gas, an air flow rate in the boiler for discharging the flue gas, an oxidizing air flow rate supplied to the absorption tower, pH of the absorption liquid in the absorption tower, or a level of the absorption liquid in the absorption tower.

With the above configuration (6), since the input parameter includes at least one of these parameters, it is possible to suitably predict, as the state quantity, the absorbent concentration of the absorption liquid in the absorption tower of the flue gas desulfurization plant.

(7) In another aspect, in the above aspect (5) or (6), the physical model includes, as a physical parameter regarding the equipment, at least one of a limestone activity, a water content in inlet gas of the absorption tower, or a humidifying rate in the absorption tower.

With the above configuration (7), since the physical parameter includes at least one of these parameters, it is possible to suitably predict, as the state quantity, the absorbent concentration of the absorption liquid in the absorption tower of the flue gas desulfurization plant.

(8) A state quantity prediction method according to one aspect is a state quantity prediction method for predicting, by using a physical model for supporting an equipment in a static state, a state quantity of the equipment corresponding to an input parameter regarding the equipment, that includes: a step of dealing with a nonlinear component of a function whose variables are dynamic characteristics of the state quantity with respect to the input parameter and a difference value between a past predictive value of the state quantity and a predictive value of the physical model, inputting the input parameter and the past predictive value of the state quantity, and including a learned neutral network for outputting a first differential predictive value; a step of dealing with a linear component of the function, inputting the input parameter and the past predictive value, and outputting a second differential predictive value; and a step of calculating a predictive value of the state quantity by integrating a differential predictive value calculated based on the first differential predictive value and the second differential predictive value.

With the above configuration (8), the function whose variable is the difference value between the past predictive value and the predictive value obtained based on the static physical model is divided into the nonlinear component and the linear component. The nonlinear component is used by the learned neural network to calculate the first differential predictive value, together with the dynamic characteristics of the state quantity with respect to the input parameter. The first differential predictive value is used to calculate the differential predictive value, together with the second differential predictive value obtained based on the one linear component. The state quantity is predicted by integrating the differential predictive value thus calculated. Thus, it is possible to accurately predict the state quantity in consideration of the dynamic characteristics, even if only the static physical model can be obtained for the equipment.

1. A state quantity prediction device for predicting, by using a physical model for supporting an equipment in a static state, a state quantity of the equipment corresponding to an input parameter regarding the equipment, comprising:
a first differential predictive value calculation unit configured to deal with a nonlinear component of a function whose variables are dynamic characteristics of the state quantity with respect to the input parameter and a difference value between a past predictive value of the state quantity and a predictive value of the physical model, input the input parameter and the past predictive value of the state quantity, and include a learned neutral network for outputting a first differential predictive value;
a second differential predictive value calculation unit configured to deal with a linear component of the function, input the input parameter and the past predictive value, and output a second differential predictive value; and
a state quantity predictive value calculation unit configured to calculate a predictive value of the state quantity by integrating a differential predictive value calculated based on the first differential predictive value and the second differential predictive value.

2. The state quantity prediction device according to claim 1,
wherein the neural network is learned together with a linear coefficient of the linear component and a physical parameter regarding the equipment included in the physical model.

3. The state quantity prediction device according to claim 2,
wherein the physical parameter is regularized if the physical parameter deviates from a preset allowable range.

4. The state quantity prediction device according to claim 1,
wherein the state quantity prediction value calculation unit is configured to integrate the differential predictive value by using, as an initial value, the state quantity satisfying a condition where the differential predictive value becomes zero.

5. The state quantity prediction device according to claim 1,
wherein the equipment is a flue gas desulfurization plant for desulfurizing a flue gas by bringing an absorption liquid into contact with the flue gas in an absorption tower, and
wherein the state quantity is an absorbent concentration of the absorption liquid in the absorption tower.

6. The state quantity prediction device according to claim 5,
wherein the input parameter includes at least one of a desulfurization outlet SO2 concentration of the absorption tower, a desulfurization inlet SO2 concentration of the absorption tower, a flow rate or a concentration of limestone slurry produced in the absorption tower, a power generation command signal with respect to a generator for generating electricity with steam produced in a boiler for discharging the flue gas, an air flow rate in the boiler for discharging the flue gas, an oxidizing air flow rate supplied to the absorption tower, pH of the absorption liquid in the absorption tower, or a level of the absorption liquid in the absorption tower.

7. The state quantity prediction device according to claim 5,
wherein the physical model includes, as a physical parameter regarding the equipment, at least one of a limestone activity, a water content in inlet gas of the absorption tower, or a humidifying rate in the absorption tower.

8. A state quantity prediction method for predicting, by using a physical model for supporting an equipment in a static state, a state quantity of the equipment corresponding to an input parameter regarding the equipment, comprising:
a step of dealing with a nonlinear component of a function whose variables are dynamic characteristics of the state quantity with respect to the input parameter and a difference value between a past predictive value of the state quantity and a predictive value of the physical model, inputting the input parameter and the past predictive value of the state quantity, and including a learned neutral network for outputting a first differential predictive value;
a step of dealing with a linear component of the function, inputting the input parameter and the past predictive value, and outputting a second differential predictive value; and
a step of calculating a predictive value of the state quantity by integrating a differential predictive value calculated based on the first differential predictive value and the second differential predictive value.
